(19) United States
(12) Patent Application Publication
(10) Pub. No.: US 2023/0284834 A1
(43) Pub. Date: Sep. 14, 2023

(54) COFFEE GRINDER WITH DEVICE FOR FILTER HOLDER OR FILTER DETECTION AND METHOD FOR DETECTING A FILTER HOLDER OR FILTER

(71) Applicant: LA MARZOCCO S.R.L., Scarperia (FI) (IT)

(72) Inventor: Andrea DIONISIO, Scarperia (FI) (IT)

(21) Appl. No.: 17/769,619

(22) PCT Filed: Oct. 19, 2020
(86) PCT No.: PCT/IB2020/059819

§ 371 Date: Apr. 15, 2022

(30) Foreign Application Priority Data
Oct. 18, 2019 (IT) 102019000019349

(51) Int. Cl. A47J 42/56; A47J 42/46; A47J 42/44; A47J 31/06; A23F 5/08

(52) U.S. Cl. CPC A47J 42/56; A47J 42/46; A47J 42/44; A47J 31/0663; A23F 5/08

(57) ABSTRACT

It is disclosed a coffee grinder machine comprising: a machine body with a motor and grinding members for grinding coffee beans; and a device for detecting the presence of a filter and/or a filter holder in a set position suitable for receiving ground coffee, wherein the detecting device comprises a normally-open switch comprising a first half-support for the filter and/or the filter holder and a second half-support for the filter and/or filter holder, and wherein the switch is configured to close when the filter and/or filter holder is in electrical contact with said first half-support and with said second half-support.

### BACKGROUND

The present invention relates to the field of espresso coffee making machines and to machines for grinding coffee grains. Such a coffee grain grinding machine may be a separate machine or may be integrated into a coffee beverage making machine. Such a machine for grinding coffee grains is also known simply as “coffee grinder machine”, “coffee grinder” or “grinder”.

More particularly, the present invention relates to a device for detecting when a filter and/or a filter holder is present in a predetermined position of a coffee grinder machine or an espresso coffee making machine.

### STATE OF THE ART

As is known, for the preparation of an espresso coffee, a certain amount of ground coffee, usually called dose, is used. The dose of ground coffee is loaded into a filter, which is typically cup-shaped, open at the top and with a micro-perforated bottom. Typically, the coffee dose is pressed into the filter to form a powdered coffee puck. The filter is in turn supported by a filter holder configured to removably engage a dispensing group of an espresso coffee machine. The espresso coffee is obtained by passing hot water under pressure through the powdered coffee puck.

The coffee powder is obtained by a coffee grinder machine. In a known coffee grinder machine, the coffee grains are ground by passing them through grinding members. Grinding members of the flat, conical or cylindrical type are known. Typically, the grinding members of a coffee grinding machine comprise a fixed member and a member which rotates with respect to the fixed member. For example, in a coffee grinder with conical grinders, one grinder remains fixed, namely stationary, while the other is rotated by a motor.

Downstream of the grinding means, the filter holder is arranged so that the ground coffee collects in the filter retained by the filter holder.

Supports for the filter holder are known. These supports constitute a support for the filter holder during the coffee grinding and the loading of the ground coffee into the filter.

Some coffee grinding machines are able to detect the presence of the filter holder when resting on the support.

For example, coffee grinding machines are known in which the detection takes place using a mechanical microswitch, an inductive sensor or a device corresponding to the weight (or mass) of the filter holder, for example a device comprising a load cell or the like.

Detection of the presence of the filter holder in place may be desirable or necessary for a plurality of reasons.

For example, detection of the filter holder can be used to start grinding the coffee grains automatically, without pressing a start key in the coffee grinder.

In addition or alternatively, the detection of the filter holder can be used to prevent the inadvertent start of the grinding if the key is pressed without the filter holder resting.

In addition or alternatively, the detection of the filter holder can be used to stop the grinding automatically as soon as the filter holder is removed.

### SUMMARY OF THE INVENTION

The Applicant has carefully observed the known devices for detecting the filter holder in coffee grinder machines or the like.

According to the Applicant, a filter holder detection system of the above type has the intrinsic limit of using a delicate component which is at high risk of breakage. In fact, the microswitches, the inductive sensors or the load cells of a sensing system based on the weight of the filter holder are delicate components.

In addition, the conditions under which they operate are critical and not optimal for at least the following reasons. The environment is dirty with coffee powder. Moreover, a coffee grinding machine is frequently subjected to washing with water or detergents by personnel who are not very respectful of the machine and in any case forced to work quickly. The bartender operates at great speed in confined spaces and often collides, unintentionally and also abruptly, with the support and/or the sensor.

According to the Applicant, the inductive sensor is advantageous in that it is contact-free but has a rather reduced reading range. Moreover, according to the Applicant, the steel filter holders are detected worse than the brass filter holders. In any case, the inductive sensor is sensitive to dirt and is also expensive.

If the presence of the filter holder is not detected or is detected in an unreliable manner, grinding may not occur or may not stop at the set time or start when not necessary. All of these situations are a hindrance to the work of the bartender and therefore affect the work of the bartender. Furthermore, in the event that the dose does not stop at the desired time or in the case where the grinding starts when not desired, the ground coffee would be wasted.

The Applicant has therefore set itself the objective of providing a reliable and robust system for detecting the presence of a filter or a filter holder in a coffee grinding machine. The device of the invention can also be used in a machine other than a coffee grinding machine. For example, it can be used in a machine for weighing the coffee dose (contained in the filter) or in a machine for pressing the ground coffee. For the purposes of the present invention, the expression “machine” or “coffee machine” (or similar expressions) will also mean an espresso coffee machine, a coffee weighing machine or a coffee pressing machine.

According to the Applicant, the above object can be obtained by providing a normally open switch comprising a first electrical contact and a second electrical contact, wherein said first electrical contact and said second electrical contact are configured to support the filter and/or the filter holder so as to close the switch by means of an electrical contact between said contacts and said filter and/or filter holder.

According to a first aspect, there is provided a coffee grinding machine comprising:
a machine body with a motor and grinding members for grinding coffee grains; and a device for detecting the presence of a filter and/or a filter holder in a predetermined position suitable for receiving ground coffee,
wherein the detection device comprises a normally open switch comprising a first half-support for the filter and/or filter holder and a second half-support for the filter and/or filter holder, and
wherein the switch is configured to close when the filter and/or filter holder is in electrical contact with the first half-support and with the second half-support.

According to embodiments, when said switch is open, at least one functionality of the coffee grinder is inhibited.

According to embodiments, when said switch is open the motor is not powered.

According to embodiments, the first half-support and the second half-support are separated by a slot and comprise a bight for the body of the filter holder.

According to embodiments, the first half-support and the second half-support define a support plane.

According to embodiments, the first half-support and the second half-support are configured to engage the filter holder at the fins projecting from the body of the filter holder.

According to embodiments, the first half-support and the second half-support are connected to a board by means of respective cables.

According to embodiments, the machine also comprises a further handle support for supporting the handle of the filter holder.

According to embodiments, the machine further comprises hooks cooperating with the half-supports to hold the filter and/or the filter holder in a predetermined position.

According to embodiments, the hooks are substantially inverted L-shaped.

According to embodiments, the hooks are at least partially of an electrically conductive material.

According to another aspect, the present invention provides a method for detecting the presence of a filter and/or a filter holder when it is in a set position in a coffee grinding machine or in an espresso coffee making machine or in a machine for weighing a dose of coffee or in a machine for pressing a dose of coffee into a filter holder, comprising: providing a filter or filter-holder detection device comprising a normally open switch comprising a first half-support for the filter or filter-holder and a second half-support for the filter or filter-holder, and closing the switch by creating an electrical contact between said filter and/or filter holder, said first support and said second support.

According to embodiments, when the switch is open, at least one function of the coffee grinder machine is inhibited.

According to embodiments, when the switch is open, the motor is not powered.

According to embodiments, a time threshold is provided between the time in which the circuit is closed by the filter and/or the filter holder and the time in which the functionality of the coffee grinder is inhibited.

### BRIEF DESCRIPTION OF THE DRAWINGS

A detailed description of the invention is now given by way of non-limiting example, to be read with reference to the accompanying figures, in which:

FIG. 1 is a schematic representation of a coffee grinder machine with filter holder detection device according to an embodiment of the invention;

FIG. 2 is a representation similar to FIG. 1 in which electrical connections are also shown;

FIG. 3 is an enlarged representation of a part of the machine of FIG. 1;

FIG. 4 is a representation of the electrical diagram of a device for detecting the filter holder;

FIG. 5.1 shows schematically a filter holder before contacting two supports of a filter holder detection device;

FIG. 5.2 shows schematically a filter holder in contact with the two supports;

FIG. 6A is a partial schematic representation of a coffee grinder machine with filter and/or filter holder detection device according to a second embodiment of the invention;

FIG. 6B is a side view of the machine of FIG. 6A;

FIG. 7 shows the machine of FIG. 6A with a filter holder which is supported cantilever;

FIG. 8A is an axonometric view of the machine of FIG. 6A with a filter on the support; and

FIG. 8B is a front view of the machine of FIG. 6A with a filter on the support.

### DETAILED DESCRIPTION

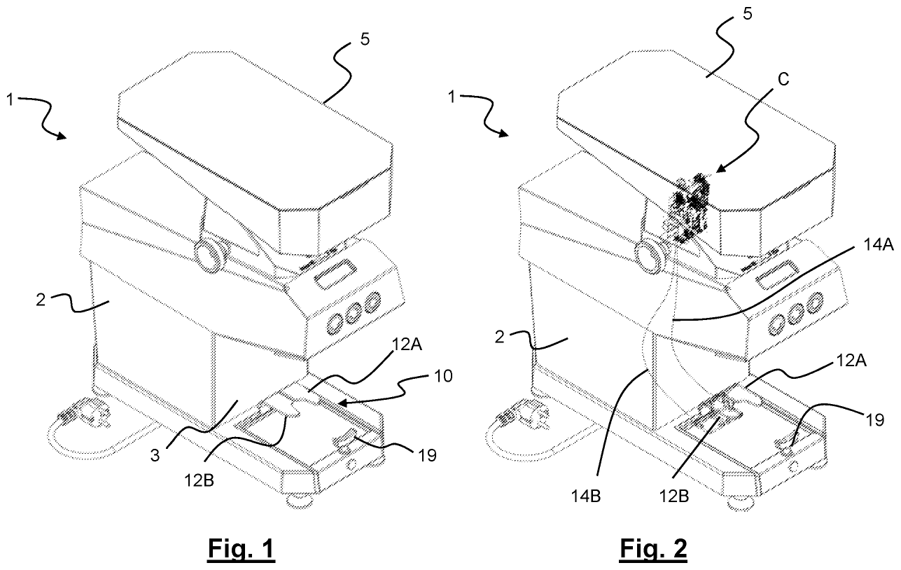

In FIG. 1, by way of example only, a coffee grinding machine 1 is shown with a device 10 for detecting the presence of the filter holder 20 in a correct position.

The coffee grinding machine 1 comprises a machine body 2 which encloses the main components, including a motor and grinding members, not shown. A hopper 5 for containing coffee beans to be grinded is mounted on the upper part.

In the lower part there is a zone 3 for the filter holder 20. During grinding, the filter holder 20 must be in a correct position so that the ground coffee collects in the filter 23.

According to a first embodiment of the present invention, the device 10 for detecting the filter holder comprises a normally open switch which is closed by means of an electrical connection between the filter holder 20 and two electrically conductive contacts 12A, 12B. According to the present invention, the two electrically conductive contacts 12A, 12B are configured to support the filter holder 20. Preferably, the two electrically conductive contacts 12A, 12B support the filter holder 20 at the body 22 of the filter holder 20 which is made of at least partially metallic material, such as steel, aluminum, brass or alloys thereof.

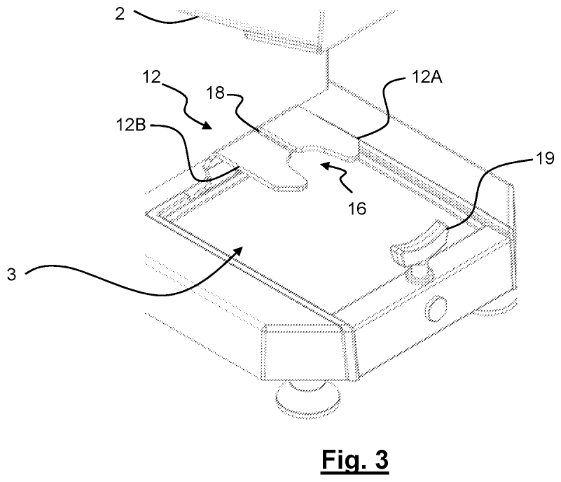

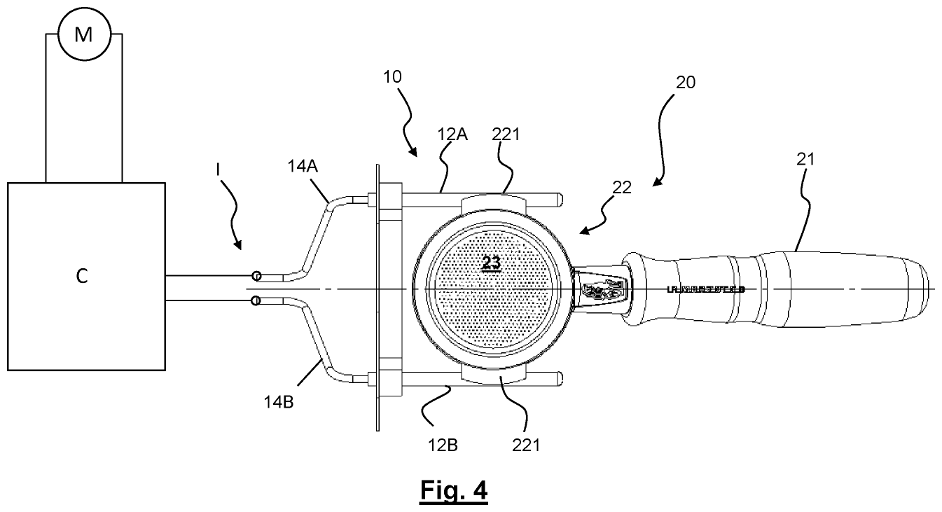

According to the embodiment of FIGS. 1-3, the two electrically conductive contacts 12A, 12B are configured to support the body 22 of the filter holder.

According to alternative embodiments, the two electrically conductive contacts 12A, 12B are configured to support the body 22 of the filter holder at the fins 221 which serve to lock the filter holder to a dispensing assembly of an espresso coffee machine.

With reference to FIGS. 1-3, according to an embodiment of the present invention, the filter holder detecting device 10 comprises a support 12 in turn comprising two half supports 12A, 12B. Each of the half-supports 12A, 12B is at least partially made of an electrically conductive material and is electrically insulated from the other half-support. As can be seen in FIGS. 1-3, for example the two half-supports 12A, 12B are separated by an empty space 18 and form a support plane with a substantially semicircular front bight 18. Of course, the supports 12A, 12B could be shaped differently without departing from the scope of the present invention.

Each half-support 12A, 12B is electrically connected to a control unit C, for example by means of an electric wire 14A, 14B.

In the absence of the filter holder, the corresponding electrical circuit is open and this inhibits at least one functionality of the coffee grinder 1. For example, it inhibits the feeding of a motor M which, by acting on one or more of the grinding members, performs the grinding of the coffee grains. Therefore, in the absence of the filter holder in position, the motor M is not supplied and cannot operate.

When the filter holder 20 is in a correct position, since its body 22 is at least partially made of metal, it closes the circuit and makes possible the otherwise prevented functionality. For example, it makes it possible to operate the motor M by means of a start key or even possibly without pressing any key. In the latter case, the motor M is configured to start immediately upon contact between the (metallic) body of the filter holder and the two half-supports.

FIG. 4 schematically shows the circuit of the switch I closed by means of the body 22 of the filter holder 20. FIG. 4 also shows the control unit C and the motor M which drives one or more of the grinding members.

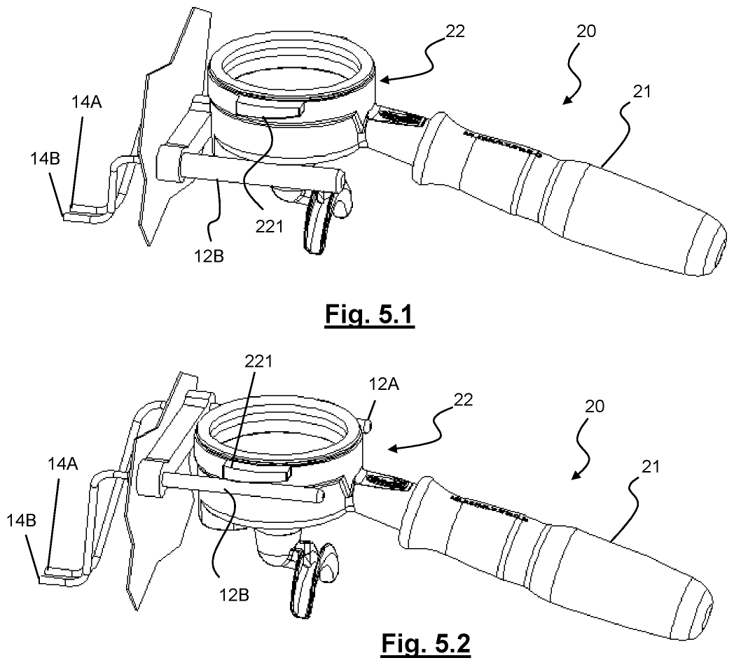

Of course, the half-supports 12A, 12B of the device of the invention may have a shape different from that shown in FIGS. 1-3. For example, each could have a cylindrical bar shape, as shown in FIGS. 4, 5.1 and 5.2.

More particularly, FIG. 5.1 schematically shows a filter holder 20 before coming into contact with the two half-supports 12A, 12B and FIG. 5.2 schematically shows a filter holder 20 in contact with the two half-supports 12A, 12B.

In addition to the supports of the body 22 of the filter holder 20, a further support 19 may also be provided to support the filter holder 20 in correspondence of at least another point. As shown in FIGS. 1-3, the further support could be a Y-shaped handle support 21 for receiving the handle 21 of a filter holder 20. In embodiments, the height of the further support 19 is adjustable to accommodate handles of different shapes and/or diameters. Height adjustment may be via a screw system.

According to embodiments, a time threshold is provided between the time in which the circuit is closed by the filter holder and the time in which, for example, the motor of a coffee grinding machine starts and possibly stops. This is to avoid the situation in which the bartender rests the filter holder on the support but immediately after he inadvertently lifts it from the support.

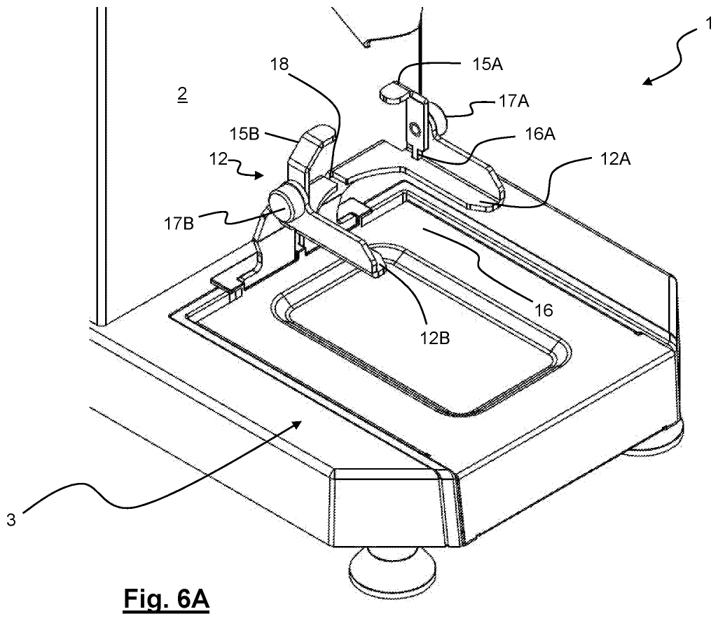

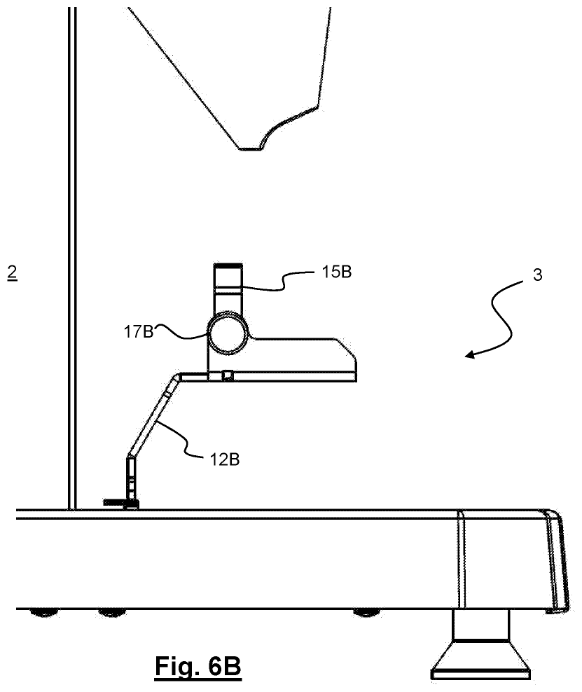

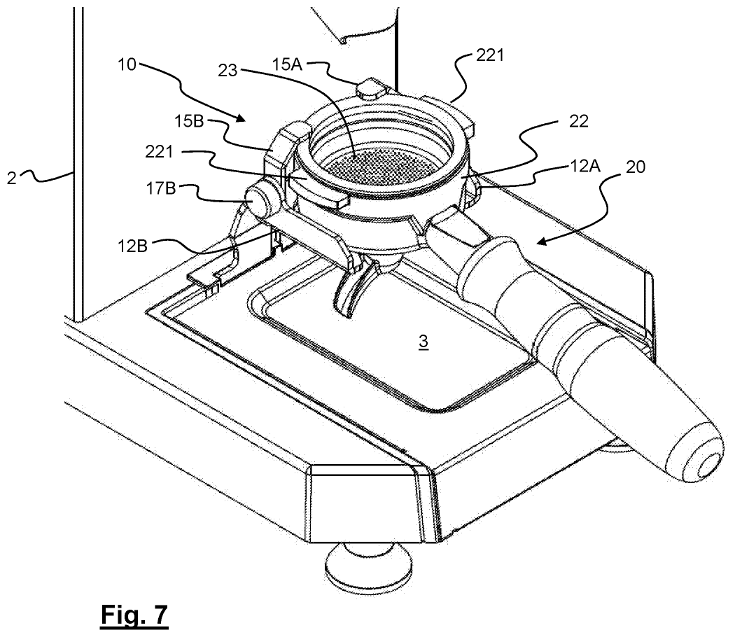

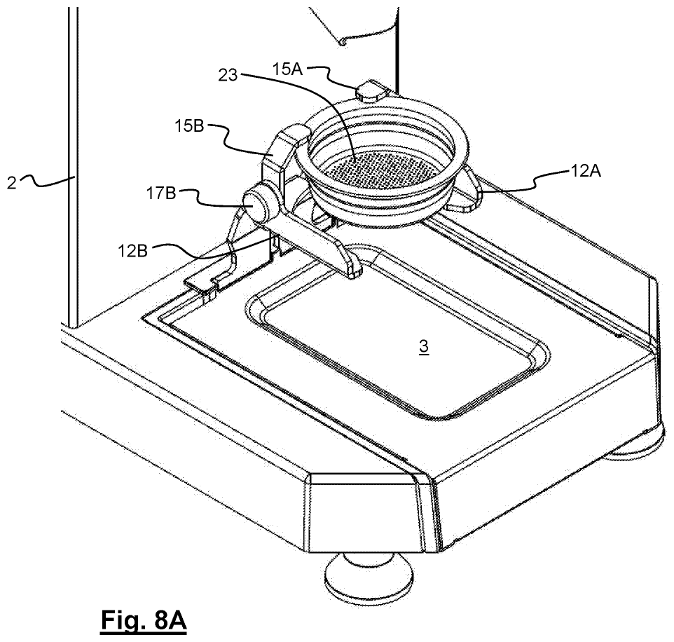

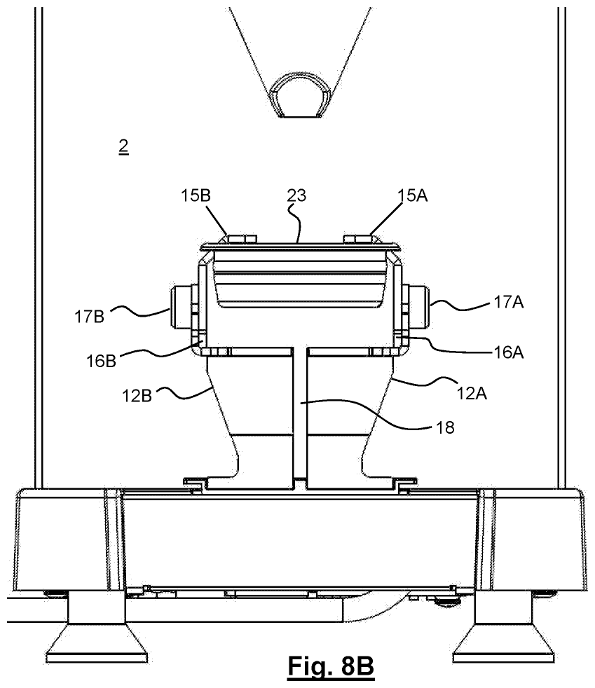

In FIGS. 6A, 6B, 7, 8A and 8B another embodiment of the present invention is shown. According to this embodiment, each half-holder 12A and 12B comprises holding hooks 15A and 15B for holding a filter holder 20 and/or a filter 23. The filter 23 can be held by the hooks 15A and 15B when it is housed in the body 22 of the filter holder 20 or, alternatively, it can be held directly (FIGS. 8A and 8B).

Each hook 15A and 15B is, for example, shaped like an inverted L and the two hooks face each other to form a sort of bridge, interrupted centrally.

According to an embodiment, the half-supports 12A and 12B have an angular profile. Each hook 15A and 15B is integral with a half-support or is fixed to a half-support. The fixing can be done, for example, by welding, with screws or other known system.

As shown for example in FIG. 6A, according to an embodiment, each hook 15A and 15B comprises a thinner lower leg 16A, 16B which engages a hole in the half-support 12A and 12B. The half-support and the hook 15A and 15B are locked together with a screw with a head that can be rotated by two fingers of a hand. In this way, the two hooks can be easily assembled and disassembled.

The half-supports 12A and 12B and the hooks are, at least partially, in an electrically conductive material. The electrical circuit described in relation to the first embodiment is closed when it is present
(a) a filter holder made of metal or other electrically conductive material and a filter; or
(b) a non-electrically conductive filter holder and a filter made of metal or any other electrically conductive material; or
(c) a filter made of metal or made of other electrically conductive material.

In other words, the circuit is closed by the filter holder and/or by the filter.

This embodiment results in several advantages. First, it is possible to use a filter holder made of a non-metallic material because the electrical contact is ensured by the filter. Secondly, it is possible not to use a filter holder at all. Thirdly, the filter holder and/or filter is prevented from tipping over. Fourthly, since the filter holder and/or the filter are not resting in correspondence with other support points, it is easier to weigh them.

1. A coffee grinder machine comprising:
a machine body with a motor and grinding members for grinding coffee beans; and a device for detecting the presence of a filter and/or a filter holder in a set position suitable for receiving ground coffee,
wherein the detecting device comprises a normally-open switch comprising a first half-support for the filter and/or the filter holder and a second half-support for the filter and/or filter holder, and
wherein the switch is configured to close when the filter and/or filter holder is in electrical contact with the first half-support and with the second half-support.

2. The machine of claim 1, wherein when the switch is open, at least one function of the coffee grinder machine is inhibited.

3. The machine of claim 2, wherein when the switch is open said motor is not powered.

4. The machine of claim 1, wherein the first half-support and the second half-support are separated by a slot and comprise a bight for the body of the filter holder.

5. The machine of claim 4, wherein the first half-support and the second half-support define a supporting plane.

6. The machine of claim 1, wherein the first half-support and the second half-support are configured to engage the filter holder in correspondence with the fins projecting from the body of the filter holder.

7. The machine of claim 1, wherein the first half-support and the second half-support are connected to a board through respective cables.

8. The machine of claim 1, further comprising a further handle support for supporting the handle of the filter holder.

9. The machine of claim 1, further comprising hooks cooperating with the half-supports to hold the filter and/or the filter holder in a predetermined position.

10. The machine of claim 9, wherein said hooks are substantially inverted L-shaped.

11. The machine of claim 9, wherein said hooks are at least partially of an electrically conductive material.

12. A method of detecting the presence of a filter or a filter holder when it is in a set position in a coffee grinder machine or in a machine for preparing espresso coffee or in a machine for weighing a dose of coffee or in a machine for pressing a dose of ground coffee in a filter holder, comprising: providing a device for detecting a filter or a filter holder comprising a normally open switch comprising a first half-support for the filter and/or the filter holder and a second half-support for the filter and/or filter holder, and closing the switch by creating an electrical contact between said filter and/or filter holder, said first half-support and said second half-support.

13. The method of claim 12, wherein when the switch is open, at least one function of the coffee grinder machine is inhibited.

14. The method of claim 13, in which when the switch is open the motor is not powered.

15. The method of claim 13, in which a time threshold is provided between the time in which the circuit is closed by the filter and/or filter holder and the time in which the functionality of the coffee grinder machine is inhibited.
